(19) United States
(12) Patent Application Publication
(10) Pub. No.: US 2025/0218288 A1
(43) Pub. Date: Jul. 3, 2025

(54) ROADSIDE APPARATUS AND NOTIFICATION METHOD

(71) Applicant: TOYOTA JIDOSHA KABUSHIKI KAISHA, Toyota-shi (JP)

(72) Inventors: Toshiki KASHIWAKURA, Tokyo-to (JP); Chihiro INABA, Tokyo-to (JP); Shoi SUZUKI, Tokyo-to (JP); Tsuyoshi OKADA, Nagoya-shi (JP); Yasuhiro KOBATAKE, Nagoya-shi (JP)

(73) Assignee: TOYOTA JIDOSHA KABUSHIKI KAISHA, Toyota-shi (JP)

(21) Appl. No.: 18/985,497

(22) Filed: Dec. 18, 2024

(30) Foreign Application Priority Data
Dec. 28, 2023 (JP) 2023-223253

(51) Int. Cl. G08G 1/01; G08G 1/16

(52) U.S. Cl. CPC G08G 1/0141; G08G 1/0116; G08G 1/0145; G08G 1/164; G08G 1/166

(57) ABSTRACT

A roadside apparatus acquires a time distance from an automated driving vehicle approaching the roadside apparatus to the roadside apparatus when a pedestrian heading toward a roadway has been detected from a video captured by the imager, and notifies the automated driving vehicle of first information indicating presence of the pedestrian and/or notifies the pedestrian of second information indicating a restriction on crossing the roadway, via the notification interface, in a case in which the acquired time distance is less than a threshold determined according to an external environment.

### CROSS-REFERENCE TO RELATED APPLICATION

This application claims priority to Japanese Patent Application No. 2023-223253 filed on Dec. 28, 2023, the entire contents of which are incorporated herein by reference.

### TECHNICAL FIELD

The present disclosure relates to a roadside apparatus and a notification method.

### BACKGROUND

Technology for notifying pedestrians and vehicles of information is known. For example, Patent Literature (PTL) 1 discloses a notification system that, according to the behavior of an automated driving vehicle scheduled to pass through a predetermined traffic area, notifies vehicles other than the automated driving vehicle, pedestrians, and the like of whether they can pass through, warning information, or the like.

### CITATION LIST

### Patent Literature

PTL 1: JP 2023-050629 A

### SUMMARY

However, PTL 1 does not disclose a viewpoint in which the need for notification of warning information is determined based on the time distance between a pedestrian heading toward a roadway and an automated driving vehicle approaching the pedestrian. Therefore, there is room for improvement with respect to technology for notifying pedestrians and vehicles of information.

It would be helpful to improve technology for notifying pedestrians and vehicles of information.

A roadside apparatus according to an embodiment of the present disclosure is a roadside apparatus including:
an imager;
a notification interface; and
a controller configured to:
   acquire a time distance from an automated driving vehicle approaching the roadside apparatus to the roadside apparatus when a pedestrian heading toward a roadway has been detected from a video captured by the imager; and
   notify the automated driving vehicle of first information indicating presence of the pedestrian and/or notify the pedestrian of second information indicating a restriction on crossing the roadway, via the notification interface, in a case in which the acquired time distance is less than a threshold determined according to an external environment.

A notification method according to an embodiment of the present disclosure is a notification method performed by a roadside apparatus, the notification method including:
acquiring a time distance from an automated driving vehicle approaching the roadside apparatus to the roadside apparatus when a pedestrian heading toward a roadway has been detected from a captured video; and
notifying the automated driving vehicle of first information indicating presence of the pedestrian and/or notifying the pedestrian of second information indicating a restriction on crossing the roadway, in a case in which the acquired time distance is less than a threshold determined according to an external environment.

According to an embodiment of the present disclosure, technology for notifying pedestrians and vehicles of information is improved.

### BRIEF DESCRIPTION OF THE DRAWINGS

In the accompanying drawings:

FIG. 1 is a block diagram illustrating a schematic configuration example of a system according to an embodiment of the present disclosure;

FIG. 2 is a schematic diagram illustrating a configuration example of a roadside apparatus;

FIG. 3 is a flowchart illustrating an example of operations of the roadside apparatus; and

FIG. 4 is a schematic diagram illustrating a traffic area.

### DETAILED DESCRIPTION

Hereinafter, an embodiment of the present disclosure will be described.

### Outline of Embodiment

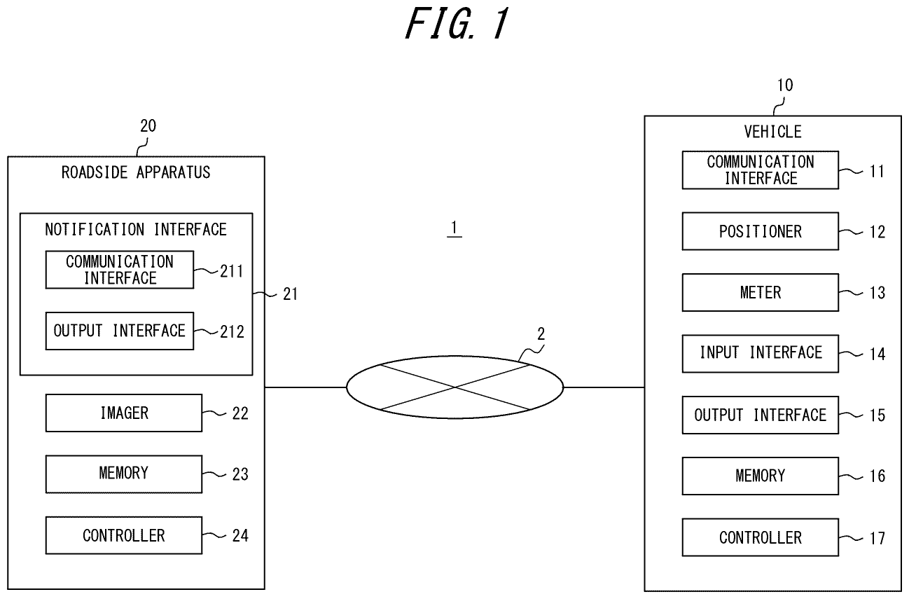

An outline of a system 1 according to an embodiment of the present disclosure will be described with reference to FIG. 1. The system 1 includes a vehicle 10 and a roadside apparatus 20. The vehicle 10 and the roadside apparatus 20 are communicably connected to a network 2 including, for example, the Internet, a mobile communication network, or the like.

The vehicle 10 is an automobile, for example, but is not limited to this and may be any appropriate vehicle. The automobile is a gasoline vehicle, a battery electric vehicle (BEV), a hybrid electric vehicle (HEV), a plug-in hybrid electric vehicle (PHEV), a fuel cell electric vehicle (FCEV), or the like, but is not limited to these. In this disclosure, the vehicle 10 shall be an automated driving vehicle 10 with an automated driving function. However, the vehicle 10 is not limited to the automated driving vehicle 10. The number of automated driving vehicles 10 included in the system 1 may be freely determined. The automated driving vehicle 10 is communicably connected to the roadside apparatus 20 via the network 2.

The roadside apparatus 20 is an information communication apparatus that, upon detecting a pedestrian heading toward the roadway from a camera video, notifies the pedestrian and also notifies the automated driving vehicle 10 approaching the pedestrian. The roadside apparatus 20 is communicably connected to the automated driving vehicle 10 via the network 2.

First, an outline of the present embodiment will be described, and details thereof will be described later. The roadside apparatus 20 acquires a time distance from the automated driving vehicle 10 approaching the roadside apparatus 20 to a pedestrian when the pedestrian heading toward a roadway has been detected from a video captured by an imager 22, and notifies the automated driving vehicle 10 of first information indicating presence of the pedestrian and/or notifies the pedestrian of second information indicating a restriction on crossing the roadway, via a notification interface 21, in a case in which the acquired time distance is less than a threshold determined according to an external environment.

Thus, according to the present embodiment, the notification to the automated driving vehicle 10 and/or the pedestrian is made when the time distance from the automated driving vehicle 10 to the roadside apparatus 20 is less than the threshold. Thus, for example, even when a pedestrian enters the blind spot of the automated driving vehicle 10 and visibility is poor, the notification of the first information and/or the second information from the roadside apparatus 20 may allow the automated driving vehicle 10 to recognize that the pedestrian is about to cross the roadway and that the pedestrian is approaching the automated driving vehicle 10. Thus, the technology for notifying pedestrians and vehicles of information is improved in that the probability of preventing traffic accidents is increased.

Next, configurations of the system 1 will be described in detail.

### Configuration of Vehicle

As illustrated in FIG. 1, the vehicle 10 (the automated driving vehicle 10) includes a communication interface 11, a positioner 12, a meter 13, an input interface 14, an output interface 15, a memory 16, and a controller 17.

The communication interface 11 includes at least one interface for communication for connecting to the network 2. The communication interface is compliant with a mobile communication standard such as the 4th generation (4G) standard or the 5th generation (5G) standard, an in-vehicle network (e.g., a Controller Area Network (CAN), or the like, for example, but is not limited to these. In the present embodiment, the automated driving vehicle 10 communicates with the roadside apparatus 20 via the communication interface 11 and the network 2.

The positioner 12 includes one or more apparatuses configured to acquire information on a position of the automated driving vehicle 10. Specifically, the positioner 12 includes, for example, a receiver compliant with GPS, but is not limited to this example and may include a receiver compliant with any appropriate satellite positioning system. Information on a position is information on the latitude and longitude of the target point.

The meter 13 includes one or more apparatuses that collect data inside and outside the automated driving vehicle 10. Specifically, one or more apparatuses, such as pressure sensors, exhaust gas sensors, accelerometers, gyro sensors, ultrasonic sensors, millimeter wave radar, infrared radar, or cameras in-vehicle cameras), measure and collect data inside and outside the automated driving vehicle 10. However, the one or more apparatuses are not limited to these. Ultrasonic sensors, millimeter wave radar, infrared radar, or cameras may be used as anti-collision sensors or obstacle detection sensors.

The input interface 14 is configured with at least one interface for input that can accept input from the driving assistance personnel of the automated driving vehicle 10. The interface for input is, for example, a physical key, a capacitive key, a pointing device, a camera, a touch screen integrally provided with a display of the output interface 15 described below, a microphone that captures voice of the driving assistance personnel, or the like. However, the interface for input is not limited to these.

The output interface 15 is configured with at least one audio output interface that can output audio, and at least one display interface that can display text or video. The interface for audio output is, for example, a speaker that outputs the first information indicating the presence of pedestrians received from the roadside apparatus 20 by audio. The display interface is, for example, a display such as an LCD or an organic EL display that outputs first information indicating the presence of pedestrians, which is received from the roadside apparatus 20, in the form of text or video. However, the audio output interface and the display interface are not limited to these.

The memory 16 includes one or more memories. The memories are, for example, semiconductor memories, magnetic memories, optical memories, or the like, but are not limited to these. The memories included in the memory 16 may each function as, for example, a main memory, an auxiliary memory, or a cache memory. The memory 16 stores any information used for operations of the automated driving vehicle 10. For example, the memory 16 may store a system program, an application program, embedded software, map information, and the like. The information stored in the memory 16 may be updated with, for example, information acquired from the network 2 via the communication interface 11.

The controller 17 includes at least one processor, at least one programmable circuit, at least one dedicated circuit, or a combination of these. The processor is a general purpose processor such as a central processing unit (CPU) or a graphics processing unit (GPU), or a dedicated processor that is dedicated to specific processing, for example, but is not limited to these. The programmable circuit is a field-programmable gate array (FPGA), for example, but is not limited to this. The dedicated circuit is an application specific integrated circuit (ASIC), for example, but is not limited to this. The controller 17 controls operations of the entire automated driving vehicle 10.

### Configuration of Roadside Apparatus

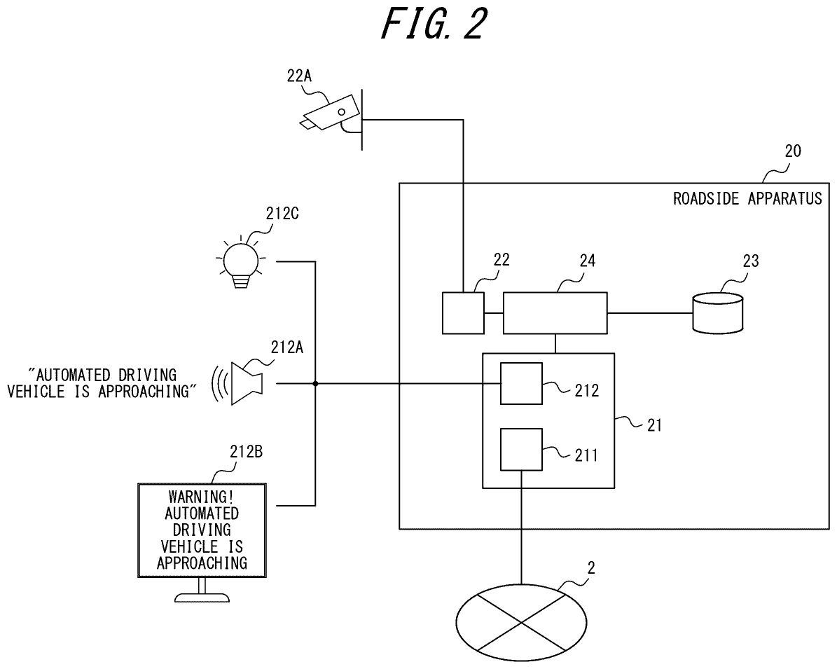

FIG. 2 is a schematic diagram illustrating a configuration example of the roadside apparatus 20. As illustrated in FIG. 1 and FIG. 2, the roadside apparatus 20 includes the notification interface 21, the imager 22, a memory 23, and a controller 24.

The notification interface 21 functions as a communication interface 211 and an output interface 212.

The communication interface 211 includes at least one interface for communication for connecting to the network 2. The communication interface may be compliant with, for example, mobile communication standards, wired local area network (LAN) standards, or wireless LAN standards, but these examples are not limiting. The communication interface may be compliant with any appropriate communication standards. In the present embodiment, the roadside apparatus 20 communicates with the automated driving vehicle 10 via the communication interface 211 and the network 2.

The output interface 212 is configured with at least one audio output interface that can output audio, at least one display interface that can display text or video, and at least one light emitting interface that can emit light. The audio output interface is, for example, a speaker 212A that audibly notifies pedestrians of second information indicating restrictions on crossing the roadway. The display interface is, for example, a display 212B, such as an

LCD or an organic EL display installed on a roadside strip or the like, that notifies pedestrians of second information indicating restrictions on crossing the roadway, such as text or video. The light emitting interface is, for example, a signal light 212C that informs pedestrians of the approach of the automated driving vehicle 10 by flashing light. The second information may be communicated to the pedestrian by using at least two of the speaker 212A, display 212B, and signal light 212C simultaneously.

The imager 22 is equipped with a video camera 22A, which captures moving images or still images of pedestrians heading toward the roadway.

The memory 23 includes one or more memories. The memories included in the memory 23 may each function as, for example, a main memory, an auxiliary memory, or a cache memory. The memory 23 stores any information to be used for operations of the roadside apparatus 20. For example, the memory 23 may store system programs, application programs, databases, images captured by the imager 22, and the like. The information stored in the memory 23 may be updated with, for example, information acquired from the network 2 via the communication interface 211.

The controller 24 includes at least one processor, at least one programmable circuit, at least one dedicated circuit, or a combination of these. The controller 24 controls operations of the entire roadside apparatus 20.

### Flow of Operations of Roadside Apparatus

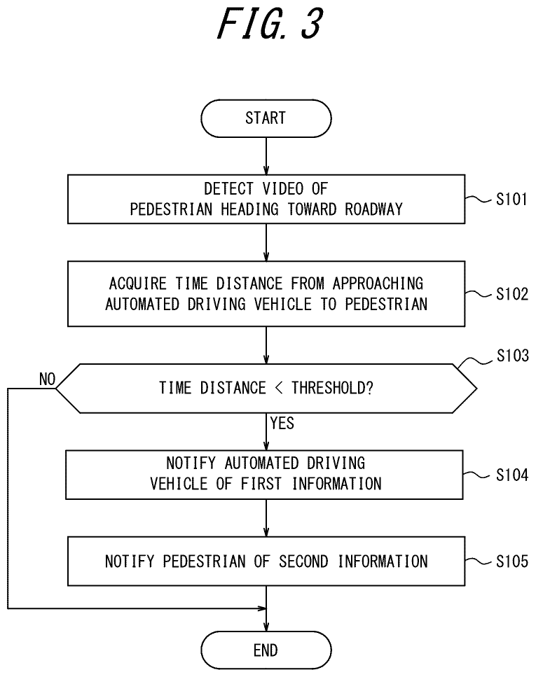

Operations of the roadside apparatus 20 according to the present embodiment will be described with reference to FIG. 3. These operations relate to the notification of information to pedestrians and automated driving vehicles 10.

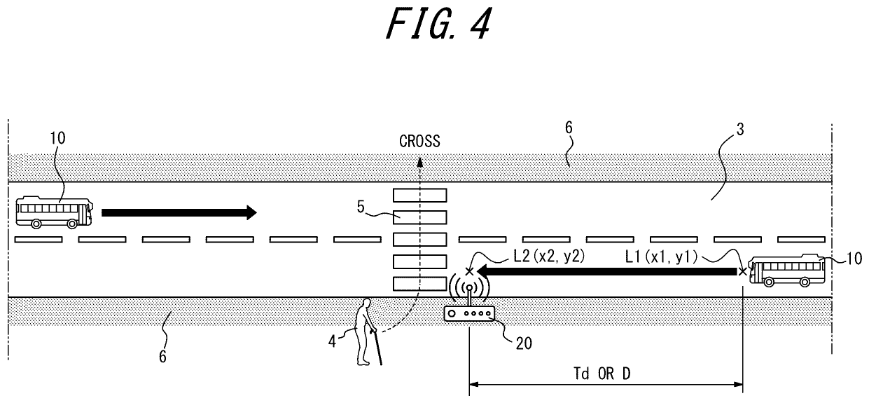

FIG. 4 is a schematic diagram illustrating a traffic area. As illustrated in FIG. 4, the automated driving vehicle 10 travels on a roadway 3 and a pedestrian 4 crosses the roadway 3 at a crosswalk 5 or the like. The roadside apparatus 20 can be installed at any location. In the example illustrated in FIG. 4, the roadside apparatus 20 is installed on the roadside strip of roadway 3, for example, in the vicinity of the crosswalk 5.

S101: The controller 24 detects pedestrians heading toward the roadway from the video captured by the imager 22.

The imager 22 captures moving images or still images of the pedestrian 4 heading toward the roadway 3 using the video camera 22A.

S102: The controller 24 acquires a time distance Td from the automated driving vehicle 10 approaching the roadside apparatus 20 to the roadside apparatus 20.

The time distance Td is the distance from one point to another expressed in terms of the time (sec) required to travel, rather than the spatial distance in kilometers. For example, the time distance Td is the time, such as two seconds (2 sec), required for the automated driving vehicle 10 to travel to the point where the roadside apparatus 20 is located. The controller 24 receives from the automated driving vehicle 10 the information on the position L1 (x1, y1) of the automated driving vehicle 10 measured by the positioner 12 and the vehicle speed S measured by the meter 13 via the communication interface 211 and the network 2. Assuming that the information on the position of the roadside apparatus 20 is L2 (x2, y2), a distance D between the automated driving vehicle 10 and the roadside apparatus 20 is calculated by the following formula (1), and the time distance Td is calculated based on the formula (2).

D²=(x1-x2)²+(y1-y2)² (1)

Td=D/S (2)

S103: The controller 24 determines whether the acquired time distance Td is less than the threshold a determined according to the external environment.

The external environment is, for example, weather, illuminance, a time period, the number of other vehicles or degree of congestion on the roadway 3, the number of pedestrians 4 detected from a video of the roadside apparatus 20, and the number of obstacles in the vicinity of the roadside apparatus 20, but the external environment is not limited to these.

S104-S105: If the acquired time distance Td is less than the threshold α, the controller 24 notifies the automated driving vehicle 10 of the first information indicating the presence of the pedestrian 4 and/or notifies the pedestrian 4 of the second information indicating the restriction on crossing the roadway 3, via the notification interface 21.

The meaning of “and/or” will be described. That is, when the acquired time distance Td is less than the threshold a, the controller 24 performs, via the notification interface 21, any of the following: (i) notifying the automated driving vehicle 10 of the first information indicating the presence of the pedestrian 4; (ii) notifying the pedestrian 4 of the second information indicating a restriction on crossing the roadway 3; and (iii) notifying the automated driving vehicle 10 of the first information indicating the presence of the pedestrian 4 and notifying the pedestrian 4 of the second information indicating a restriction on crossing the roadway 3.

The controller 24 sets the threshold a (sec) based on at least one of (i)-(vi) described below, for example. The controller 24 may adopt a particular threshold α from (i) through (vi), or the threshold α with the largest value from (i) through (vi).
(i) If the weather is rainy, cloudy, or foggy, a threshold α with a larger value may be set compared with the case of the weather being sunny. For example, the controller 24 may set the threshold α=3 sec when the weather is rainy and the threshold α=2 sec when the weather is sunny. In the case of the weather being rainy, visibility is worse than in the case of the weather being sunny, so it becomes necessary to notify the automated driving vehicle 10 of the first information and the pedestrian 4 of the second information earlier.
(ii) If the illuminance is less than a reference value, a threshold α with a larger value may be set compared with the case of the illuminance being equal to or greater than the reference value. Illuminance is a physical quantity that expresses the brightness of light illuminating the surface of an object, and the unit of illuminance is expressed in lux (1×). For example, if the illuminance in the daytime during cloudy weather (e.g., 32,000 1×) is used as the reference value, the threshold α=3 sec may be used if the illuminance is less than 32,000 1×, and the threshold α=2 sec if it is equal to or greater than 32,000 1×. When the illuminance is lower than the reference value, visibility becomes poor, and it becomes necessary to notify the automated driving vehicle 10 of the first information and the pedestrian 4 of the second information as soon as possible.
(iii) If the time period is nighttime, a threshold α with a larger value may be set compared with the case of the time period being daytime. For example, the controller 24 may set the threshold α for nighttime as α=5 sec and the threshold α for daytime as α=2 sec. In the nighttime, the visibility is worse than in the daytime, so it becomes necessary to notify the automated driving vehicle 10 of the first information and the pedestrian 4 of the second information earlier.
(iv) If the number of other vehicles or the degree of congestion on the roadway 3 is less than a reference value, a threshold α with a larger value may be set compared with the case of the number of other vehicles or the degree of congestion on the roadway 3 being equal to or greater than the reference value. For example, when the number of vehicles traveling within a predetermined area is less than a reference value, or when the degree of congestion is less than a reference value, the automated driving vehicle 10 can travel at a higher speed compared with the case of the number of vehicles traveling within the predetermined area or the degree of congestion being equal to or greater than the reference values. Therefore, when the number of other vehicles or the degree of congestion on the roadway 3 is less than the reference value, it becomes necessary to notify the automated driving vehicle 10 of the first information and the pedestrian 4 of the second information earlier compared with the case of the number of other vehicles or the degree of congestion on the roadway 3 being equal to or greater than the reference value.
(v) If the number of pedestrians 4 detected from the video of the roadside apparatus 20 is equal to or greater than a reference value, a threshold α with a larger value may be set compared with the case of the number of pedestrians 4 detected from the video of the roadside apparatus 20 being less than the reference value. If the number of pedestrians 4 is equal to or greater than the reference value, the risk of pedestrians 4 suddenly entering the roadway 3 increases, and it becomes necessary to notify the automated driving vehicle 10 of the first information and the pedestrians 4 of the second information as soon as possible.
(vi) If the number of obstacles in the vicinity of the roadside apparatus 20 is equal to or greater than a reference value, a threshold α with a larger value may be set compared with the case of the number of obstacles in the vicinity of the roadside apparatus 20 being less than the reference value. Obstacles are, for example, trees, telephone poles, or building structures. If the number of obstacles in the vicinity of the roadside apparatus 20 is equal to or greater than the reference value, the visibility becomes poor and it becomes necessary to notify the automated driving vehicle 10 of the first information and the pedestrian 4 of the second information as soon as possible.

According to this configuration, the threshold α is set with a larger value than at normal times (in the daytime or when it is sunny) in the environments where visibility is relatively poor such as in the nighttime or when it is rainy, thereby notifying the automated driving vehicle 10 and/or the pedestrian 4 even when the automated driving vehicle 10 is located farther away from the roadside apparatus 20, and traffic safety thus may be improved.

The controller 24 may set more than one threshold α. For example, the controller 24 may set a first threshold α1 and a second threshold α2 that is a larger value than the first threshold α1, and in a case in which the time distance Td is less than the first threshold α1, notify, via the notification interface 21, the automated driving vehicle 10 and/or the pedestrian 4 of a message, as the first information and/or the second information, respectively, encouraging a more urgent response compared with a case in which the time distance Td is equal to or greater than the first threshold α1 and less than the second threshold α2.

The meaning of “and/or” will be described. That is, when the time distance Td is less than the first threshold α1, the controller 24 performs, via the notification interface 21, any of the following: (i) notifying the automated driving vehicle 10 of a message encouraging a more urgent response as the first information; (ii) notifying the pedestrian 4 of the message as the second information; and (iii) notifying the automated driving vehicle 10 of the message as the first information and notifying the pedestrian 4 of the message as the second information.

If the time distance Td is equal to or greater than the first threshold α1 and less than the second threshold α2, the controller 24 may notify the automated driving vehicle 10 and the pedestrian 4 of a message encouraging a less urgent (weak warning) response, such as “There is a pedestrian” or “Please cross the street with caution to the automated driving vehicle”, as the first information and the second information. On the other hand, if the time distance Td is less than the first threshold α1, the controller 24 may notify the automated driving vehicle 10 and the pedestrian 4 of a message encouraging a more urgent response (strong warning), for example, a message such as “Beware of pedestrian jumping out” or “No crossing”, as the first information and the second information. Such notifications allow the automated driving vehicle 10 and the pedestrians 4 to respond to the urgency of the situation.

The output interface 212 includes the signal light 212C that informs pedestrians of the approach of the automated driving vehicle 10 by, for example, flashing light. The controller 24 may flash the signal light 212C at a higher speed when the time distance Td is less than the first threshold α1 and at a lower speed when the time distance Td is equal to or greater than the first threshold α1 and less than the second threshold α2. However, other methods of flashing the signal light according to the degree of urgency may be employed, such as changing the color of the light.

When the automated driving vehicle 10 receives a notification from the roadside apparatus 20, for example, “Beware of pedestrians jumping out”, the probability of avoiding a traffic accident is improved by decelerating or stopping. A driving assistance personnel on board the automated driving vehicle 10 may receive the notice “Beware of pedestrian jumping out” output by voice or text/video from the speaker or display included in the output interface 15 of the automated driving vehicle 10, and manually decelerate or stop the automated driving vehicle 10.

As described above, the roadside apparatus 20 according to the present embodiment acquires a time distance Td from the automated driving vehicle 10 approaching the roadside apparatus 20 to the roadside apparatus 20 when a pedestrian heading toward a roadway 3 has been detected from a video of the imager 22, and notifies the automated driving vehicle 10 of first information indicating presence of the pedestrian 4 and/or notifies the pedestrian 4 of second information indicating a restriction on crossing the roadway 3, via the notification interface 21, in a case in which the acquired time distance Td is less than a threshold α determined according to an external environment.

According to such a configuration, the notification to the automated driving vehicle 10 and/or the pedestrian 4 is made when the time distance Td from the automated driving vehicle 10 to the roadside apparatus 20 is less than the threshold α. Thus, for example, even if the pedestrian 4 enters the blind spot of the automated driving vehicle 10 and has poor visibility, the notification of the first information and/or the second information from the roadside apparatus 20 allows the automated driving vehicle 10 to recognize that the pedestrian 4 is about to cross the roadway 3 and the pedestrian 4 to recognize that the automated driving vehicle 10 is approaching. Thus, the technology for notifying pedestrians 4 and vehicles 10 of warning information is improved in that the probability of preventing traffic accidents is increased.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, the functions and the like included in each component, step, or the like can be rearranged in a logically consistent manner. Components, steps, or the like may also be combined into one or divided. For example, an embodiment in which the configuration and operations of the roadside apparatus 20 in the above embodiment are distributed to a plurality of roadside apparatuses capable of communicating with each other can also be implemented.

For example, an embodiment in which a general purpose computer functions as the roadside apparatus 20 according to the above embodiment can also be implemented. Specifically, a program in which processes for realizing the functions of the roadside apparatus 20 according to the above embodiment are written may be stored in a memory of a general purpose computer, and the program may be read and executed by a processor. Accordingly, the present disclosure can also be implemented as a program executable by a processor, or a non-transitory computer readable medium storing the program.

1. A roadside apparatus comprising:
an imager;
a notification interface; and
a controller configured to:
acquire a time distance from an automated driving vehicle approaching the roadside apparatus to the roadside apparatus when a pedestrian heading toward a roadway has been detected from a video captured by the imager; and
notify the automated driving vehicle of first information indicating presence of the pedestrian and/or notify the pedestrian of second information indicating a restriction on crossing the roadway, via the notification interface, in a case in which the acquired time distance is less than a threshold determined according to an external environment.

2. The roadside apparatus according to claim 1, wherein the external environment is weather, illuminance, a time period, a number of other vehicles or degree of congestion on a roadway, a number of pedestrians detected from a video of the roadside apparatus, and a number of obstacles in a vicinity of the roadside apparatus.

3. The roadside apparatus according to claim 2, wherein the controller is configured to:
set, in a case in which the weather is rainy, cloudy, or foggy, a threshold with a larger value compared with a case of the weather being sunny;
set, in a case in which the illuminance is less than a reference value, a threshold with a larger value compared with a case of the illuminance being equal to or greater than the reference value;
set, in a case in which the time period is nighttime, a threshold with a larger value compared with a case of the time period being daytime;
set, in a case in which the number of other vehicles or the degree of congestion on the roadway is less than a reference value, a threshold with a larger value compared with a case of the number of other vehicles or the degree of congestion on the roadway being equal to or greater than the reference value;
set, in a case in which the number of pedestrians detected from the video of the roadside apparatus is equal to or greater than a reference value, a threshold with a larger value compared with a case of the number of pedestrians detected from the video of the roadside apparatus being less than the reference value; and
set, in a case in which the number of obstacles in the vicinity of the roadside apparatus is equal to or greater than a reference value, a threshold with a larger value compared with a case of the number of obstacles in the vicinity of the roadside apparatus being less than the reference value.

4. The roadside apparatus according to claim 1, wherein the controller is configured to:
set a first threshold and a second threshold that is a larger value than the first threshold; and
notify the automated driving vehicle of a message as the first information and/or notify the pedestrian of the message as the second information, via the notification interface, in a case in which the time distance is less than the first threshold, the message encouraging a more urgent response than a case in which the time distance is equal to or greater than the first threshold and less than the second threshold.

5. A notification method performed by a roadside apparatus, the notification method comprising:
acquiring a time distance from an automated driving vehicle approaching the roadside apparatus to the roadside apparatus when a pedestrian heading toward a roadway has been detected from a captured video; and
notifying the automated driving vehicle of first information indicating presence of the pedestrian and/or notifying the pedestrian of second information indicating a restriction on crossing the roadway, in a case in which the acquired time distance is less than a threshold determined according to an external environment.
